(19) United States
(12) Patent Application Publication
(10) Pub. No.: US 2025/0370450 A1
(43) Pub. Date: Dec. 4, 2025

(54) METHOD FOR CONTROLLING A REMOTELY CONTROLLABLE MEMBER INVOLVING ONE OR MORE MOVING OBJECTS

(71) Applicant: MMA, Sofia (BG)

(72) Inventor: Kalin KANTCHEV, Sofia (BG)

(73) Assignee: MMA, Sofia (BG)

(21) Appl. No.: 18/880,144

(22) PCT Filed: Jun. 30, 2023
(86) PCT No.: PCT/EP2023/067952

§ 371 Date: Dec. 30, 2024

(30) Foreign Application Priority Data
Jun. 30, 2022 (FR) FR2206685

(51) Int. Cl. G05D 1/221; G05D 1/244; G05D 109/10; G05D 111/10; G06T 7/90

(52) U.S. Cl. CPC G05D 1/221; G05D 1/244; G06T 7/90; G05D 2109/13; G05D 2111/10

(57) ABSTRACT

A method for monitoring a remotely controllable member includes: transmitting a data signal between a movable object and a fixed point, the data signal being transmitted by an electromagnetic radiation source to a receiver of the electromagnetic radiation by modulation of the electromagnetic radiation, the source and the receiver being coupled respectively to the fixed point and to the movable object or vice versa; providing a masking device configured to limit a field of emission and/or reception of the signal to an area including the fixed point and defined by the masking device; defining by the processing unit a command executable by the remotely controllable member, according to data extracted from the signal, the position of the transmission area, and/or the orientation of the movable object; transmitting the command to the remotely controllable member for execution.

### TECHNICAL FIELD

The present invention relates to the monitoring and/or triggering of actions, following the individual or simultaneous location of one or more movable objects, by one or several remotely controllable members integrated or not into the movable objects. The movable object(s) may be for example of the badge, bicycle, kick scooter, scooter, robot or drone type, fitted or not with a drive for example an electric drive.

### PRIOR ART

Today, many cities are equipped with automated rental systems that provide the public with a fleet of vehicles that can be used for a limited duration, for example less than a day, to make a journey. This solution aims in particular to relieve congestion on public transport and reduce car traffic within cities. The fleet of vehicles can be deployed with or without parking stations installed in different spots in a territory where the vehicles in the fleet are used. Each of these stations comprises terminals allowing locking vehicles between two rental periods and for example recharging the batteries of the vehicles if they are electrically driven.

In the case of a fleet deployed without stations, the vehicles are in communication with a central system to transmit their respective geographic positions. The vehicles also include their own locking means controlled by the central system. The central system transmits to users wishing to rent a vehicle the positions of the available vehicles. The start and end of a vehicle rental are determined and stored by the central system when a user requests it from the central system, which then controls the unlocking or locking of the vehicle.

However, the development of this type of service is compromised by a minority of users who are disrespectful of other users of public spaces and traffic rules. Indeed, it is common for a vehicle, in particular of the kick scooter type, to be used inappropriately, for example in a pedestrian area or on sidewalks, or even without respecting traffic lights and directions. In the case of a fleet deployed without stations, it is also common for a vehicle to be abandoned in the middle of a sidewalk or on a building exit. The geographic location means fitted to the vehicles are not precise enough to enable the central system to determine whether the vehicle is parked in an inconvenient spot. In the case of a bicycle or a kick scooter, it is also not possible for the central system to determine whether the vehicle is standing or lying down. Furthermore, it turns out that public authorities are only able to oppose such incivilities to a very limited extent and tend to prohibit this type of service, which penalizes managers of the service and users who behave appropriately.

It is therefore desirable to be able to remotely monitor the movements of movable objects. In the context of a self-service vehicle rental service, it may also be desirable to be able to ensure that the vehicles are returned at the end of rental to specific spots, and if possible, correctly stored in the case of a vehicle sharing system without reserved parking spots. It may also be desirable to monitor robots or drones in a delimited space, for example a goods storage shed, or to monitor access to a room or department by authorized persons, or even to broadcast a voice or video message to a person in a delimited place.

### SUMMARY OF THE INVENTION

Embodiments relate to a method for monitoring a remotely controllable member, the method comprising steps consisting in: transmitting a data signal between a movable object and a fixed point, the data signal being transmitted by an electromagnetic radiation source to a receiver of the electromagnetic radiation by modulation of the electromagnetic radiation, the source and the receiver being coupled respectively to the fixed point and to the movable object or vice versa; providing a masking device comprising one or several elements masking the electromagnetic radiation, the masking device being configured to limit a field of emission and/or reception of the data signal to a transmission area including the fixed point and defined by the masking device; extracting data from the data signal by a processing unit connected to the receiver; defining by the processing unit a command executable by the remotely controllable member, according to the extracted data, the position of the transmission area, and/or the orientation of the movable object; transmitting the command by the processing unit to the remotely controllable member; and executing the command by the remotely controllable member.

Thus, it is possible to remotely monitor one or several movable objects according to their position and orientation in space, or to trigger commands when the movable object is in a certain position defined as a function of the masking device.

According to one embodiment, the method comprises steps consisting in: receiving by at least two receivers of a set of receivers installed on the movable object two data signals transmitted by electromagnetic radiation emitted respectively by two fixed electromagnetic radiation sources, the field of emission and/or reception of the data signals emitted by each of the two sources being limited to a respective transmission area defined by a masking device; extracting, by the processing unit of the movable object connected to the set of receivers, an electromagnetic radiation source identifier from each received data signal; determining by the processing unit of the movable object connected to the set of receivers, a location area and a direction of a preferred axis of movement of the movable object in a plane of movement of the movable object, as a function of the identifiers of the two electromagnetic radiation sources and of the receivers having received the data signals, and executing by the processing unit, a command of an electromechanical member of the movable object as a function of the location area and the direction of the preferred axis of movement of the movable object.

In this way, it is possible to determine whether the movable object is precisely in a position and orientation defined by the masking device and to trigger the command only if this condition is met.

According to one embodiment, the command belongs to a set of commands comprising: a command to limit the speed of the movable object, a command to stop the movement of the movable object, and a command to lock the movable object.

According to one embodiment, the method comprises steps consisting in: determining by the processing unit whether the location area of the movable object is located in an authorized parking area of the movable object as a function of the emitter identifier, executing by the processing unit an end-of-use command when the location area is located in an authorized parking area, the end-of-use command comprising a command to lock the movable object, and a transmission to a remote server of an end-of-use notification message, containing a location data and an identifier of the movable object, and not executing by the processing unit the end-of-use command as long as the location area is not located in an authorized parking area.

According to one embodiment, the movable object is located in an area comprising a plurality of data signal emitters, the method further comprising a step of determining a geographic position of the movable object as a function of the emitter identifier extracted from the signal received from one of the emitters.

According to one embodiment, the data signal is emitted by modulating the supply current of an electromagnetic radiation source, belonging to the emission installation.

According to one embodiment, the modulation of the supply current is of the SPWM type.

Embodiments may also relate to a device to be installed on a movable object, the device comprising: a receiver assembly comprising at least one electromagnetic radiation receiver, each receiver of the receiver assembly being associated with a respective masking device limiting an angle of incidence by which the receiver can receive the electromagnetic radiation, each masking device having a respective orientation, and a processing unit connected to the receiver assembly and to an interface to be linked to a control member of the movable object, the device being configured to implement the previously defined method.

According to one embodiment, the receiver assembly comprises a front receiver block to be installed in a front position of the movable object and a rear receiver block to be installed in a rear position of the movable object, each of the front and rear receiver blocks being connected to the processing unit and bringing together several electromagnetic radiation receivers, the receivers of each of the front and rear receiver blocks being associated with respective masking devices having distinct orientations for capturing electromagnetic radiation having distinct orientations.

According to one embodiment, the receiver assembly comprises an image sensor, the processing unit being configured to analyze images provided by the image sensor in order to determine the presence of an image area having a predefined color.

### BRIEF DESCRIPTION OF THE FIGURES

The present invention will be better understood from the following description of exemplary embodiments, with reference to the appended figures, in which identical reference signs correspond to structurally and/or functionally identical or similar elements.

FIG. 1 schematically represents an object emitting an electromagnetic field transmitting a data signal to a receiving object, according to one embodiment,

FIG. 2 schematically represents a set of circuits installed in the receiving object, according to one embodiment,

FIG. 3 schematically illustrates the case where the receiving object is located in the electromagnetic field emitted by the emitting object and another emitting object, according to one embodiment,

FIG. 4 schematically illustrates the case where a receiving object with two emitters is located in the electromagnetic field emitted by the emitting object, according to one embodiment,

FIG. 5 schematically represents an object emitting an electromagnetic field transmitting a data signal to a receiving object, according to another embodiment,

FIG. 6 schematically represents a set of circuits installed in the emitting object and the receiving object, according to one embodiment,

FIG. 7 schematically represents an object emitting an electromagnetic field transmitting a data signal to a receiving object, according to another embodiment,

FIG. 8 schematically represents two objects emitting an electromagnetic field transmitting a data signal to a receiving object with two receivers, according to one embodiment,

FIG. 9 schematically represents an object emitting an electromagnetic field transmitting a data signal, and three receiving objects, according to another embodiment,

FIG. 10 schematically represents a vehicle in an electromagnetic field transmitting a data signal, according to one embodiment,

FIG. 11 schematically represents the vehicle fitted with data signal sensors, according to one embodiment,

FIG. 12 is a schematic perspective view of a front sensor block installed on the vehicle, according to one embodiment,

FIG. 13 is a schematic perspective view of a rear sensor block installed on the vehicle, according to one embodiment,

FIG. 14 schematically represents a set of circuits installed in the vehicle, according to one embodiment,

FIG. 15 schematically represents a parking area fitted with a device for emitting an electromagnetic field, according to one embodiment,

FIG. 16 schematically represents different areas fitted with devices for emitting an electromagnetic field, according to one embodiment,

FIG. 17 represents curves of signal variation over time illustrating a method for transmitting data by modulation of electromagnetic radiation, according to one embodiment,

FIG. 18 schematically represents a set of circuits installed in the vehicle, in communication with a remote processing unit, according to another embodiment.

### DETAILED DESCRIPTION

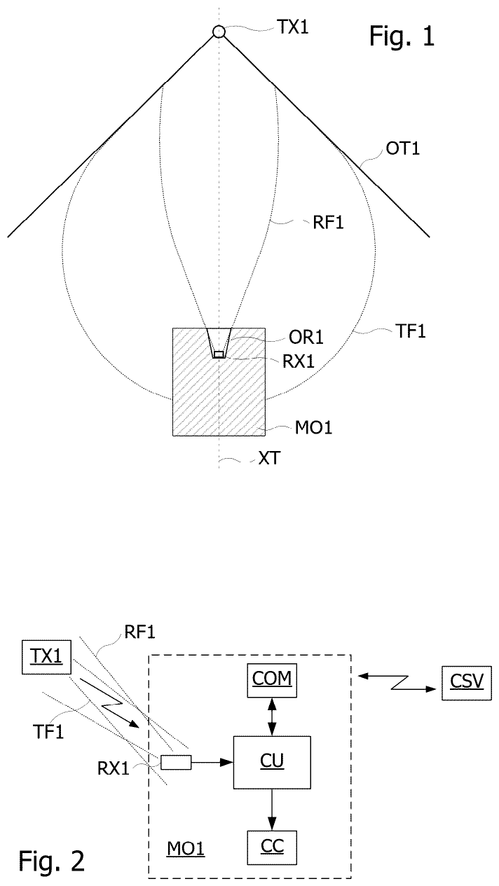

FIG. 1 represents an emitter TX1 of electromagnetic radiation in a field TF1 and transmitting a data signal to a receiving object MO1, according to one embodiment. The emitter TX1 can be fixed, while the receiving object is movable. The transmission of the data signal can be performed by amplitude modulation of the electromagnetic radiation. The transmitted data can comprise an identifier of the emitting object TX1. The emitting object TX1 can be associated with a masking device OT1 comprising one or several elements masking the electromagnetic radiation, the masking device being configured to limit the emission field TF1 to a transmission area whose shape is defined by the configuration of the masking device.

The receiving object MO1 comprises a receiver RX1 which can also be associated with a masking device OR1 defining the shape of a reception field RF1. When the emitting object TX1 and the receiver RX1 are simultaneously located in the emitting TF1 and receiving RF1 fields, the data signal emitted by the emitter TX1 can be received by the receiver RX1.

According to one embodiment, the exposed faces of the masking device OT1 and/or OR1 are treated to reduce or prevent reflections of electromagnetic radiation.

In the example of FIG. 1, the masking device OT1 has the shape of a cone, the emitter TX1 being disposed inside the cone at the top of the latter. The masking device OR1 has the shape of a well formed in the receiving object MO1, the receiver RX1 being disposed at the bottom of the well. Thus, the emission field TF1 is wider than the reception field RF1. Thanks to the masking devices OT1, OR1, it is possible to modulate the degree of precision both at the emission level and at the reception level, including being able to perfectly align two objects on the same straight line XT.

FIG. 2 represents an electric circuit installed in the receiving object MO1, according to one embodiment. According to one embodiment, the receiving object MO1 comprises a control unit CU connected to the receiver RX1. The control unit CU is configured to extract data from the data signal received by the receiver. The control unit CU can be configured to determine a position of the receiving object MO1 based on an identifier of the emitter TX1 and a reception area defined by the masking device associated with the receiver, as well as based on the position and the width of the emission field generated by the emitter TX1. The position and the width of the emission field generated by the emitter TX1 can be determined from the data transmitted by the data signal.

According to one embodiment, the receiving object MO1 is fitted with a communication circuit COM connected to the control unit CU to communicate with a remote server CSV, in particular to transmit to it, for example in real time, an identifier of the receiving object, an emitter TX1 identifier. The server CSV can thus locate the receiving object MO1 in real time. The communication between the communication circuit COM and the server CSV can be established via a telephone, for example of the “smartphone” type, which can be that of a user of the receiving object. The link between the circuit COM and the telephone SM can be of the BLE (“Bluetooth Low Energy”) type.

The control unit CU can be configured to control a control circuit CC of the receiving object MO1 as a function of position of the latter determined in a reference frame of the emitter TX1 and the data received from the latter.

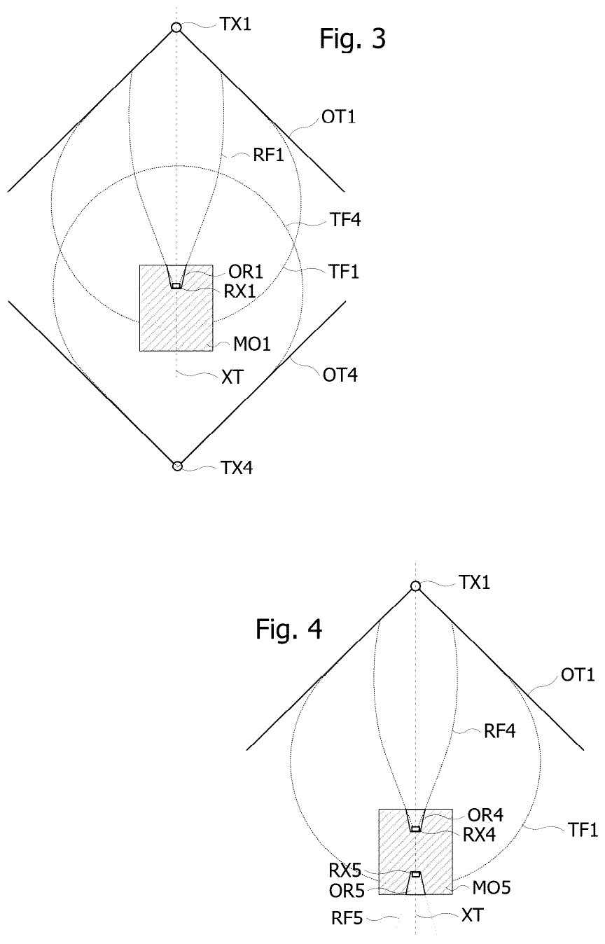

It should be noted that the receiver can receive signals from different objects emitting electromagnetic radiation, but that, thanks to the masking device OT1 and/or OR1 and the positioning of the emitting object TX1, the receiver RX1 receives at any time at most one data signal from a single emitting object. Thus, FIG. 3 illustrates the case where the receiving object MO1 is located in the electromagnetic fields TF1, TF4 emitted respectively by the emitter TF1 and another emitter TX4. The data signal emitted by the emitter TX4 cannot be received by the receiver RX1 because the reception field RF1 of the latter does not include the emitter TX4.

FIG. 4 illustrates the case of a receiving object MO5 comprising two receivers RX4, RX5 respectively having reception fields RF4, RF5 located in opposite directions and delimited by respective masking devices OR4, OR5. The object MO5 is placed in the emission field TF1 of the emitting device TX1. Since only the reception field TF4 encompasses the emitter TX1, only the corresponding receiver RX4 receives the data signal emitted by the emitter TX1. Thus, the orientation of the receiving object MO1 in a reference frame linked to the emitter TX1 can be determined with even greater precision as the masking device OR1 or OT1 has a reduced opening. In the example of FIG. 4, the presence of the two receivers RX4, RX5 enables the processing unit CU connected to the latter to determine which face of the object MO5, associated with the masking device OR4, OR5 is facing the receiver TX1, based on an identifier of the receiver RX4, RX5 having received the data signal.

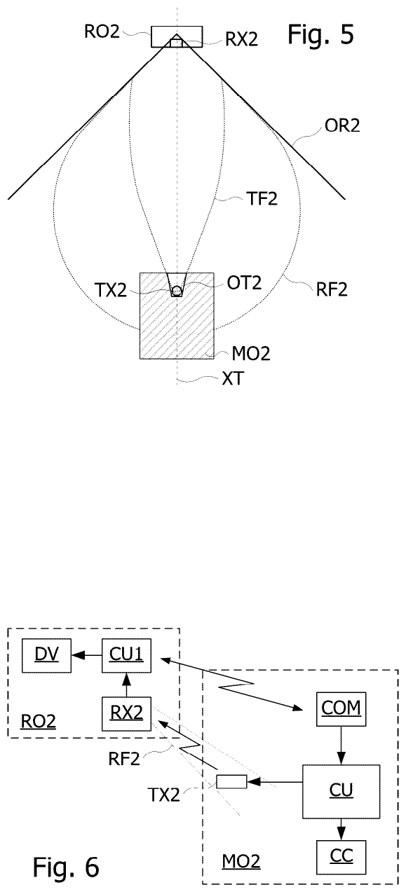

FIG. 5 represents an object MO2 emitting an electromagnetic field TX2 transmitting a data signal to a receiving object RO2, according to another embodiment. FIG. 5 differs from FIG. 1 in that the emitter is movable and the receiver is fixed, the object MO2 differs from the object MO1 in that it includes an emitter TX2 in place of the receiver RX1.

The receiver RX2 of the receiving object RO2 can be associated with a masking device OR2 comprising one or several elements masking the electromagnetic radiation, the masking device being configured to limit the reception field RF2 to a transmission area whose shape is defined by the configuration of the masking device. The emitter TX2 can also be associated with a masking device OT2 defining the shape of an emission field TF2. When the emitter TX2 and the receiver RX2 are simultaneously located in the emitting TF2 and receiving RF2 fields, the data signal emitted by the emitter TX2 can be received by the receiver RX2.

FIG. 6 represents the emitting object MO2 and the receiving object RO2. The data signals received by the receiver RX2 are transmitted to a processing unit CU1 which processes these signals to extract therefrom the data comprising the identifier of the emitting object TX2. The processing unit CU1 can be configured to determine an order to be transmitted to the emitting object TX2, taking into account the position of the receiving object RO2, known to the processing unit CU1, and the identifier of the emitting object transmitted by the data signals received from the receiver RX2. The order thus determined by the processing unit CU1 can be transmitted to the processing unit CU of the object MO2 via another transmission channel, for example by a wireless network such as a WiFi-type network or a mobile network or even a Bluetooth-type link which may thus be automatically established due to the proximity between the fixed point and the movable object. The control unit CU1 can also control other devices such as a device DV located near the receiver RX2 and connected to the processing unit CU1. The device DV can be for example a door opening latch or a fixed anti-theft device, or a device for emitting a sound, light or video signal or message. Thus, the movable object can simply be a badge worn by a user and having a device for emitting the data signal in the form of electromagnetic radiation. The command to be executed can be the triggering of the opening of a door or the broadcasting of a sound, light or video message in relation to an object in the immediate environment of the fixed point, for example a work of art or a machine. The masking device OR2 and/or OT2 can allow limiting the area where the emitting object MO2 must be located to trigger the emission of the command by the control unit CU1 to the device CC and/or DV to be controlled. The device to be controlled can for example provide access to a room or to services.

In the example of FIG. 6, the masking device OT2 has the same shape as the masking device OR1, the receiver RX2 being disposed inside the cone at the top of the latter. The masking device OT2 has the same shape as the masking device OR1, the emitter TX2 being disposed at the bottom of the well. Thus, the reception field RF2 is wider than the emission field TF2. Thanks to the masking devices OT2, OR2, it is possible to modulate the degree of precision both at the emission level and at the reception level, including being able to perfectly align two objects on the same straight line XT.

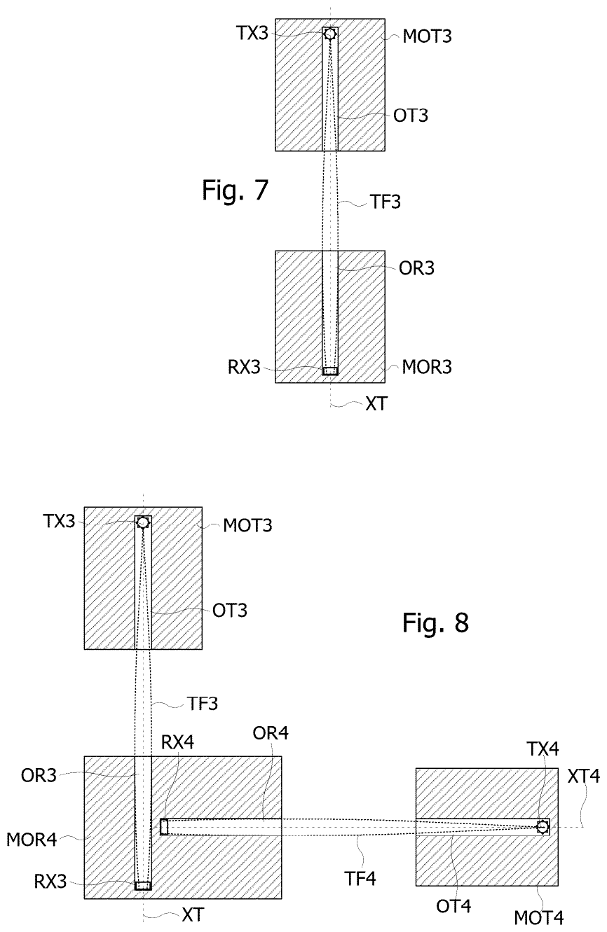

Depending on the requirements for fine location on a precise axis, it is possible to achieve extreme levels of precision by placing the emitter and the receiver at the bottom of wells at depths and diameters adapted to the precision requirement. Thus, FIG. 7 represents an emitting object MOT3 comprising an emitter TX3, and a receiving object MOR3 comprising a receiver RX3. The emitter TX3 is associated with a well-shaped masking device OT3 at the bottom of which it is placed. Similarly, the receiver RX3 is associated with a well-shaped masking device OR3 at the bottom of which it is placed. In this way, the emission field TF3 can have a very narrow width, and can be likely to be received by the receiver RX3 at the bottom of the well OR3 only on condition that the emission and reception fields are perfectly aligned along the same axis XT. The configuration of the masking device OT3 or OR3 allows achieving axial linear location.

FIG. 8 shows a receiving object MOR4 that differs from the receiving object MOR3 in that it comprises a second receiver RX4 that can be associated with a masking device OR4. FIG. 8 also represents the emitting device MOT3 as well as another emitting device MOT4 comprising an emitter TX4 that can be associated with a masking device OT4. Under these conditions, the receiving device MOR4 can be located in space relative to the emitters TX3 and TX4 when the receivers RX3, RX4 of the receiving device MOR4 simultaneously receive data signals from the emitters TX3, TX4. The precision of the location depends on the shape of each of the masking devices OT3, OR3, OT4, OR4. In the case where the masking devices OT3, OT4, OR3, OR4 are wells, the reception device MOR4 can be precisely located in space when the receiver RX3 is on the axis XT of the emission field TF3 of the emitter TX3 and the receiver RX4 is on the axis XT4 of the emission field TF4 of the emitter TX4. When the reception device MOR4 is in this position, a command can be emitted by the processing unit CU of the reception device MOR4. Such location precision can also be achieved by reversing the positions of the emitters and receivers.

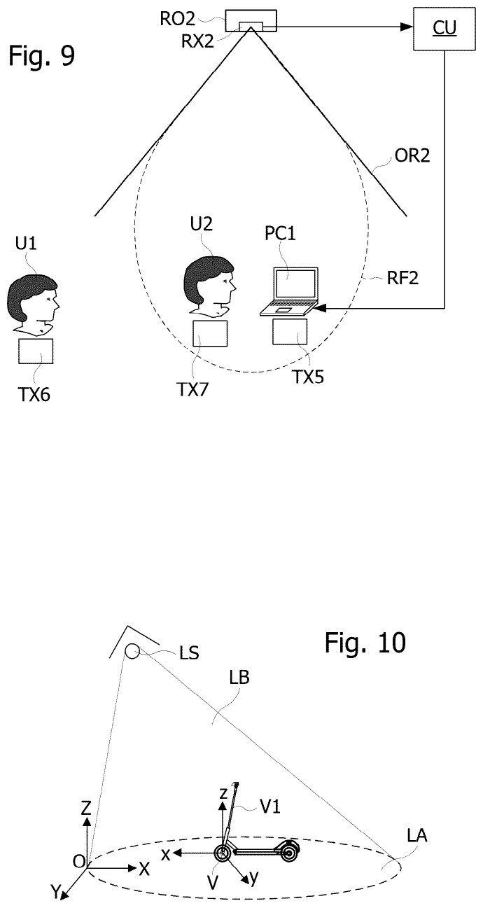

FIG. 9 illustrates another embodiment in which two emitters must be seen at the same time by a receiver. This embodiment allows, for example, monitoring the use by users of apparatuses such as personal computers or access to services provided via a personal computer. This embodiment comprises an emitting device such as the emitting device RO2 fitted with the emitter RX2 and the masking device OR2, the emitting device being connected to the control unit CU. Authorized users U1, U2 carry respective emitting devices TX6, TX7, such as badges fitted with an emitter for example infrared. The apparatuses such as the apparatus PC1 are associated in a tamper-proof manner with a respective emitting device TX5. The control unit CU is configured to authorize the use of the apparatus PC1, as long as the receiver receives valid data signals from both the emitter TX5 associated with the apparatus PC1 and one of the emitters TX6, TX7 of one of the authorized users U1, U2. As long as this condition is met, the control unit UC sends an enabling signal to the apparatus PC1 that allows it to be used. If this condition is not or no longer met, the control unit CU stops sending the enabling signal (for example at regular intervals) or sends a prohibiting signal. The apparatus PC1 is configured to be able to be used or to give access to a service only as long as it receives the enabling signal, or only after receiving the enabling signal and as long as it does not receive the prohibiting signal. Use of the computer PC1 or access to a service may be further conditional on the execution of a user authentication procedure, in combination with the enabling and/or prohibiting signal.

FIG. 10 represents a vehicle V1 disposed in an electromagnetic field, for example a light field LB, emitted by a signal emission device LS, according to one embodiment. The electromagnetic field emitted by the source covers an area LA on the ground. According to one embodiment, the intensity of the electromagnetic field LB is modulated to transmit a data signal that may comprise identification data. The data signal comprises for example an identifier of the emission device LS. The data signal may also comprise other data, for example, data relating to the illuminated area LA. The modulation is for example performed in amplitude. The vehicle V1 comprises one or several sensors configured to receive the electromagnetic field LB and a demodulation circuit to extract the identification signal from the electromagnetic field LB.

The emission device LS emits electromagnetic radiation in a wavelength band including visible light, and which propagates in the atmosphere, but not in most solid materials such as materials not transparent to visible light.

The signal emission device LS may for example be a street lighting lamppost or specific street furniture provided with an electromagnetic radiation source, and the light field LB may be that emitted by one or several bulbs installed in the lamppost or on a mast or any other construction.

The shape of the emitted electromagnetic field LB can be defined by one or several shutters and/or by optical lenses.

According to one embodiment, the data transmitted by the field LB comprise in particular data which may belong to the set bringing together the following data:
an identifier of the area LA illuminated by the field LB or of the emission device LS,
a type of area illuminated by the field LB, and
a list of identifiers of signal emission devices, illuminating areas adjacent to the area LA, each adjacent area being able to be associated with a type of area.

The type of area can be one of the following:
a pedestrian area or a sidewalk,
a pedestrian crossing,
an area adjacent to a pedestrian crossing,
an area adjacent to or including a traffic light,
an area adjacent to or including a stop,
a one-way traffic area,
an area located on the edge of an authorized traffic area,
an area closed to fleet vehicle traffic,
a reserved parking area for vehicles of the fleet.

In addition, the data transmitted by the field LB may vary over time, or only be emitted during certain time slots.

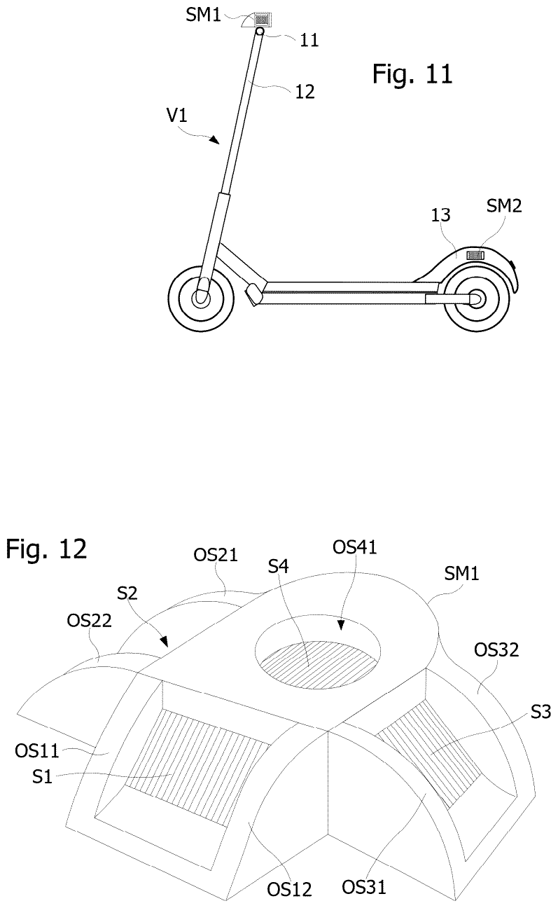

FIG. 11 represents the vehicle V1, according to one embodiment. The vehicle V1 is fitted with sensor assemblies SM1, SM2 configured to receive electromagnetic signals of the type emitted by the emission device LS. The sensor assemblies SM1, SM2 comprise a front sensor assembly SM1 configured to be installed at the front of the vehicle V1 and a rear sensor assembly SM2 configured to be installed at the rear of the vehicle V1. In the example of FIGS. 11 and 12, the vehicle V1 is a kick scooter. According to one embodiment, the front sensor assembly SM1 is installed on the handlebar 11 of the kick scooter V1, or at the top of the front post 12 supporting the handlebar, and the rear sensor assembly SM2 is installed on or in the mudguard 13 of the rear wheel of the kick scooter.

According to one embodiment, each of the sensors SM1, SM2 of the vehicle is associated with a masking device comprising one or several elements masking the electromagnetic radiation. Each masking device is configured to limit a reception field of the data signal to a transmission area including the emission device LS, and defined by the masking device. The masking device is further configured to prevent the transmission to the sensor with which it is associated of another data signal which would be emitted by another source by modulation of the electromagnetic radiation when the vehicle is in the transmission area.

FIG. 12 represents the front sensor assembly SM1, according to one embodiment. The front sensor assembly SM1 comprises a front sensor S1, two right S2 and left S3 lateral sensors and a zenith sensor S4. According to one embodiment, each of the front S1 and lateral S2, S3 sensors is associated with a masking device OS11, OS12, OS21, OS22, OS31, OS32 arranged so as to limit the width of the field observed by the sensor. Similarly, the zenith sensor S4 is associated with a masking device OS41 forming a well at the bottom of which the sensor Z4 is disposed. The zenith sensor S4 at the bottom of its well OS41 allows locating the vehicle very precisely in a horizontal plane.

FIG. 13 represents the rear sensor assembly SM2, according to one embodiment. The rear sensor assembly SM2 comprises a rear sensor S11 and two right S12 and left S13 lateral sensors. Each of the rear S11 and lateral S12, S13 sensors is associated with masking devices OS51, OS53, OS53, for example forming a cavity at the bottom of which the sensor is disposed, to limit the width of the field observed by the sensor or the angle of incidence by which the sensor may be illuminated. Lenses may also be placed in front of the sensors S1-S4, S11-S13 to capture or discriminate certain directions of electromagnetic rays, and thus allow easily detecting for example whether the vehicle V1 is standing or lying down.

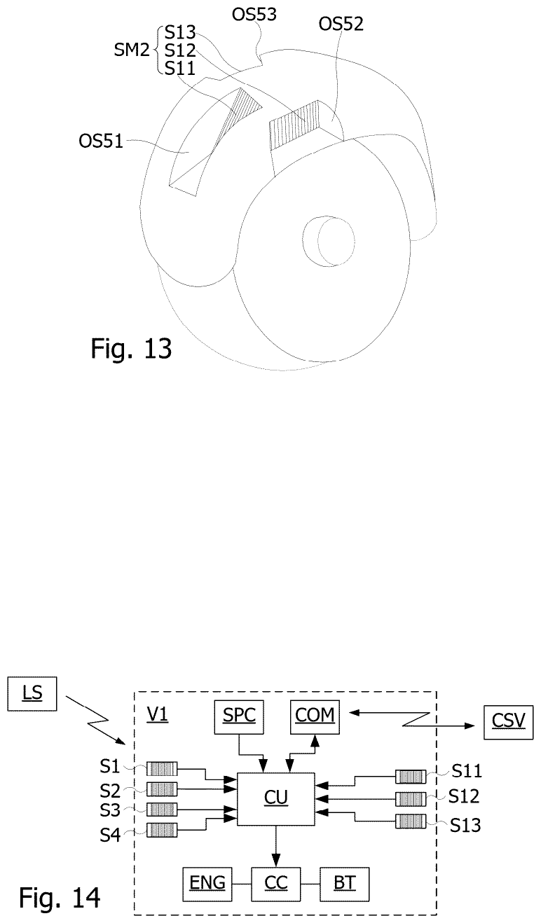

In general, the arrangement of a sensor S1-S4, S11-S13 at the bottom of a well allows precisely locating the vehicle V1 in a plane perpendicular to the axis of the well. By distributing the sensors and electromagnetic sources in a suitable manner, it is thus possible to precisely determine the position and the orientation of the vehicle. More generally, the number and the arrangement of the sensors as presented as examples in FIGS. 13 and 14, as well as the position and the orientation of the emission devices may vary and are more generally adapted to the configuration of the vehicle and to the intended application.

FIG. 14 represents an electric circuit installed in the vehicle V1, according to one embodiment, in the case where the vehicle V1 is driven by an electric motor ENG. The motor ENG of the vehicle V1 is linked to a battery BT through a control circuit CC ensuring the powering up of the motor and the monitoring of the speed of the motor as a function of position of a manual accelerator control. According to one embodiment, the electric circuit of the vehicle V1 comprises a control unit CU connected to the sensors S1-S4, S11-S13 of the sensor assemblies SM1, SM2. The control unit CU is configured to demodulate the signals received by each of the sensors S1-S4, S11-S13 in order to determine the data transmitted by the emission device(s) LS located nearby emitting an emission field covering one of the sensors despite the masking device associated with it. The control unit CU is also configured to determine a position V of the vehicle V1 in a fixed reference frame OXYZ linked to the device for emitting the signal LS received by one of the sensors S1-S4, S11-S13, based on an identifier of the sensor receiving the signal LS and a reception area defined by the masking device associated with the sensor, as well as based on the position and the width of the emission field generated by the emission of the signal LS. The position and the width of the emission field generated by the signal LS may be determined from the data transmitted by the signal.

In the example of the kick scooters, the control unit CU may also determine that the vehicle is substantially vertical when the data signal LS is received by the sensor S4 at the bottom of the well S41.

It should be noted that the sensors S1-S4, S11-S13 may receive signals from different data signal emission devices, but that, thanks to the masking devices and the positioning of the emission devices, each of the sensors receives at any time at most one data signal from a single emission device LS.

According to one embodiment, the vehicle V1 is fitted with a communication circuit COM connected to the control unit CU to communicate with a remote server CSV, in particular to transmit to it, for example in real time, a vehicle identifier, an emission device LS identifier, for example the last identifier received. The server CSV may thus locate all the vehicles in a fleet in real time. The communication between the communication circuit COM and the server CSV may be established via a telephone SM, for example of the “smartphone” type, which may be that of the user. The link between the circuit COM and the telephone SM may be of the BLE (“Bluetooth Low Energy”) type.

The vehicle V1 may also be fitted with a satellite positioning device SPC, for example of the GPS (“Global Positioning System”) or Galileo type. Such a device may be useful if the vehicle cannot locate itself because it is not in the emission field LB of an emission device LS and if it is not supported by a user or for any other reason.

The control unit CU is configured to control the control circuit CC of the motor ENG as a function of position of the vehicle V1 determined in the reference frame OXYZ and the data received from the emission devices located nearby.

Depending on a type of area that may appear in the received data, the command applied by the control unit CU to the control circuit CC may be a command to stop the motor ENG, in particular if the type of area received is a pedestrian area or a one-way traffic area and the direction of movement of the vehicle is opposite to the authorized direction of movement, or if the area is closed to fleet vehicle traffic. The command applied by the control unit CU to the control circuit CC may be a speed reduction or limitation command associated with a maximum speed, when the received type of area is an area adjacent to a stop sign, a traffic light or a pedestrian crossing and the direction of movement of the vehicle tends to bring the vehicle closer to the stop sign, the traffic light or the pedestrian crossing. The command applied by the control unit CU to the control circuit CC may be a vehicle locking command linked to an end of rental of the vehicle, in particular if the vehicle V1 is not motorized, but is fitted with a locking device capable of being controlled remotely.

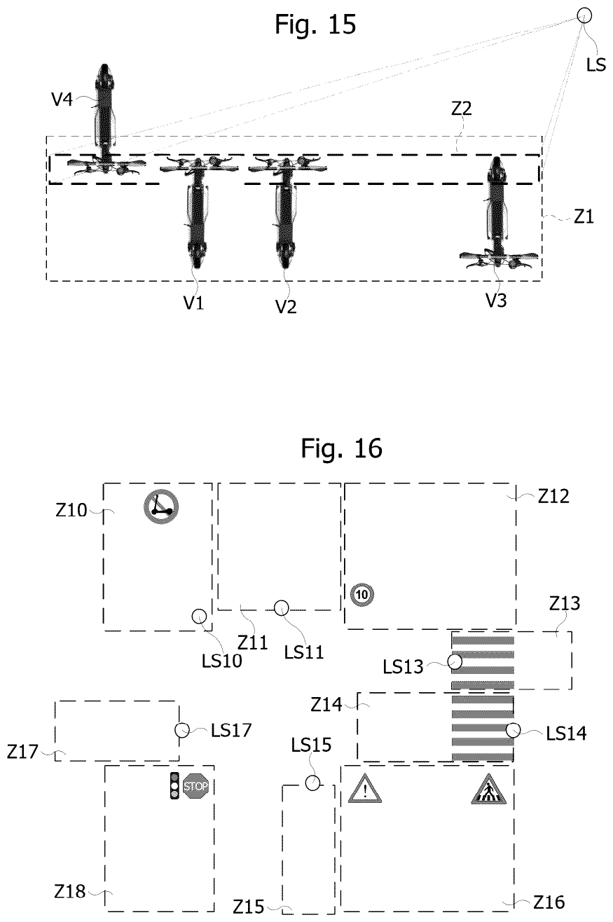

FIG. 15 represents a parking area Z1 where the vehicles V1, V2, V3, V4 of the fleet may be abandoned at the end of their rental. The parking area Z1 is illuminated by an electromagnetic radiation source LS having an emission field covering a strip-shaped ground area Z2, in which the handlebars of the vehicles V1-V4 must be positioned. In the example of FIG. 15, the vehicles V1, V2, V4 have their handlebars positioned above the strip Z2, while the handlebar of the vehicle V3 is not positioned above the strip Z2 but in the parking area Z1. The vehicle V4 is not positioned on the parking area Z1. The right front sensor S2 of the vehicles V1 and V2 receives the radiation emitted by the source LS, while the other sensors of the vehicles V1, V2 do not receive this radiation since they are located outside the emission field of the source LS. Only the left rear sensor S13 of the vehicle V3 is located in the emission field of the source LS. The left front sensor S3 of the vehicle V4 receives the radiation emitted by the source LS, while the other sensors of the vehicle V4 do not receive this radiation since they are located outside the emission field of the source LS.

According to one embodiment, the control unit CU is configured to determine that a vehicle V1-V4 is correctly placed on the parking area Z1, based on the identifier transmitted by the data signals received by the different sensors. In the case of the vehicles V1, V2, the control unit CU determines that the data signals received by the right front sensors S2, S3 are correct (the identifier of the source LS is received only by the right front sensor S2), and that the other sensors, and in particular the sensor S4 of the vehicles do not receive these data signals, indicating that they are substantially vertical. The control unit CU deduces therefrom that the vehicles V1 and V2 are correctly positioned in the parking area Z1. In the case of the vehicle V3, the control unit CU determines that the data signals emitted by the source LS are not received by the right front sensor S2 and therefore that the vehicle V3 is incorrectly positioned on the parking area Z1. In the case of the vehicle V4, the control unit CU determines that the data signals emitted by the source LS are not received by the front sensor S2, but by the left front sensor S3, and therefore that the vehicle V3 is positioned upside-down relative to the required position on the parking area Z1. Under these conditions, the control unit CU may determine that an end of rental is only permitted for the vehicles V1, V2. Thus, with at least one electromagnetic radiation source LS, it is possible to determine an orientation of the vehicles.

Thus, the control unit CU may thus determine the position of a reference frame V, x, y linked to the vehicle in the reference frame OXY of one of the emission devices LS, LS1 having transmitted an identifier to the control unit CU. The control unit CU may also transmit the position of the reference frame V, x, y to the server CSV.

With more electromagnetic radiation sources covering the same area, it is possible to more accurately determine the position and the orientation of the vehicles V1-V4.

It should also be noted that the sensors installed on the vehicles may be replaced by electromagnetic radiation sources and the source LS may be replaced by an electromagnetic radiation sensor. In this configuration, a control unit linked to the sensor may locate the vehicles and

According to one embodiment, the sensors S1-S4, S11-S13 are simple photovoltaic cells. More generally, the sensors are elements sensitive to a band of wavelengths of an electromagnetic radiation and provide an electrical signal representative of the variations in intensity or wavelength of the received radiation. Thus, one or several of the sensors S1-S4, S11-S13 may be image sensors, for example cameras. With an image sensor, the command to be executed by the vehicle may be determined according to a color appearing in the image provided by the image sensor. According to one example, the image provided by a camera may be analyzed to determine whether a traffic light is visible in the image and is red or green, the command provided to the vehicle V1 being determined accordingly.

It should also be noted that the vehicle V1 may only be fitted with two sensors, for example a sensor at the front of the vehicle and a sensor at the rear of the latter, in particular if it is necessary to evaluate only the position and the direction Vx of the vehicle V1 in a movement plane OX, Y linked to the signal emission devices LS. Furthermore, if the aim is only to force users to return the vehicles at the end of rental to certain parking areas (for example Z1), a single sensor installed on the vehicle is sufficient to detect that the vehicle is in one of these areas.

FIG. 16 illustrates different situations that can be managed by the control unit CU. FIG. 16 presents an area Z10 receiving an electromagnetic field emitted by a source LS10. The identifier transmitted by the source LS10 corresponds to an area where the circulation of the vehicles V1 is prohibited. Upon receiving the signal emitted by the source LS10, the control unit CU is configured to stop the motor ENG of the vehicle V1.

FIG. 16 presents an area Z11 receiving an electromagnetic field emitted by a source LS11, located at the entrance of an area Z12 where the speed is limited. Upon receiving the signal emitted by the source LS11, the control unit CU of the vehicle V1 is configured to control the motor ENG of the vehicle V1, in order to reduce the speed of the vehicle to reach the maximum authorized speed.

FIG. 16 presents pedestrian crossing areas Z13, Z14, receiving an electromagnetic field emitted by sources LS13, LS14 respectively. Upon receiving the signal emitted by the source LS13 or LS14, the control unit CU is configured to control the motor ENG of the vehicle V1, in order to reduce the speed of the vehicle to reach the speed set for traversing the pedestrian crossings.

FIG. 16 presents an area Z15 receiving an electromagnetic field emitted by a source LS15, located at the entrance of an area Z16 where the vehicles coming from another direction have priority. Upon receiving the signal emitted by the source LS15, the control unit CU is configured to control the motor ENG of the vehicle V1, in order to reduce the speed of the vehicle to reach a speed allowing the immediate stopping of the vehicle in case of presence of another vehicle in the area Z16.

FIG. 16 presents an area Z17 receiving an electromagnetic field emitted by a source LS17, located at the entrance of an area Z16 including a traffic light or a stop sign. Upon receiving the signal emitted by the source LS17, the control unit CU is configured to control the motor ENG of the vehicle V1, in order to reduce the speed of the vehicle to reach a speed allowing the immediate stopping of the vehicle at the stop sign or at the traffic light.

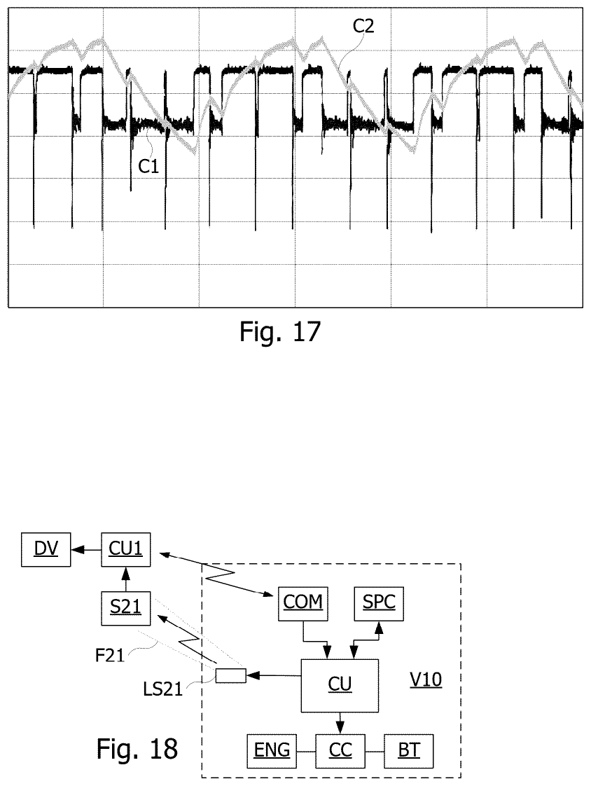

According to one embodiment, the signal emitted by the emission device LS is generated by powering a light source such as a LED (Light Emitting Diode) using a signal modulated in SPWM (Sinusoidal Pulse Width Modulation) whose frequency may be set to a value greater than 1 MHz, the signal having a duty cycle modulated sinusoidally at a frequency comprised between 1 and 22 kHz. FIG. 17 shows curves C1, C2, of variation over time, the curve C1 corresponding to the power supply signal of the source LS, and the curve C2 corresponding to the resulting signal emitted by the source LS, as it may be received by one of the sensors S1-S4, S11-S13 of the vehicle V1. The remanence of the light source allows obtaining a substantially sinusoidal signal when the duty cycle of the power supply signal of the light source is varied in a certain way. The transmission of data to the processing unit CU may be performed by varying the frequency of the sinusoidal signal thus produced.

In the above, the electromagnetic radiation emitters are for example light (visible light) sources or sources in infrared wavelengths (from near infrared to far infrared), knowing that at longer wavelengths, the emitted fields may less easily be channeled.

It will be clear to those skilled in the art that the present invention is susceptible to various variants and various applications. In particular, the invention is not limited to the arrangement of electromagnetic radiation emitters at fixed points and receivers on movable objects. Indeed, the receivers may be fixed and the emitters may be disposed on the movable objects, without departing from the scope of the present invention. In this case, a control unit is linked to each receiver and may thus identify the movable objects and for example send them commands through another transmission channel.

Thus, FIG. 18 represents a movable object V10 which differs from the vehicle V1 in that the sensors are replaced by one (or several) source LS21 of electromagnetic radiation. The source LS21 continuously or periodically emits a data signal comprising an identifier of the movable object V10. Fixed sensors such as the sensor S21 are disposed in the environment of the movable object V10. A masking device is associated with the source LS21 or the sensor S21 to limit the transmission field between the source LS21 and the sensor S21 to a field F21. The data signals received by the sensor S21 are transmitted to a processing unit CU1, for example the server CSV, which processes these signals to extract therefrom the data comprising the identifier of the movable object V10. The processing unit CU1 may be configured to determine an order to be transmitted to the movable object V10, taking into account the position of the sensor S21, known to the processing unit, and the identifier of the movable object transmitted to the sensor by the data signals. The order thus determined by the processing unit CU1 may be transmitted by the processing unit to the processing unit CU of the movable object V10 via another transmission channel, for example by a wireless network such as a WiFi-type network or a mobile network or a Bluetooth-type link which may thus be established automatically due to the proximity between the fixed point and the movable object. The control unit CU1 may also control devices external to the movable object.

Thus the command to be executed emitted by the processing unit CU1 is not necessarily intended for the movable object V10, but it may be executed by a device DV to be controlled located near the fixed point and connected to the processing unit CU1. The device DV may be for example a door opening latch or a fixed anti-theft device, or a device for emitting a sound, light or video message or signal. Thus the movable object may simply be a badge worn by a user and having a device for emitting the data signal in the form of an electromagnetic radiation. The command to be executed may be the triggering of the opening of a door or the broadcasting of a sound, light or video message in relation to an object in the immediate environment of the fixed point, for example a work of art or a machine. In this case, the masking device may be associated with the receiving device S21 disposed at the fixed point to limit the area where the movable object must be located to trigger the command by the control unit CU1 linked to the receiving device S21. The masking device may also be associated with the source LS21.

The invention is also not limited to the monitoring of a fleet of vehicles in an urban space, but also applies to the monitoring of a single vehicle or more generally, to the monitoring of one or several movable objects in an open or closed space such as for example inside a building. The invention may also be used in any other space, as long as this space is fitted with at least one electromagnetic radiation emitter. The movable objects may be for example drones or robots.

The invention is also not limited to a movable object fitted with several sensors. Indeed, a single sensor may be sufficient to determine in particular whether the movable object is in an authorized area or not, or more generally an area where the command must be activated.

The identification signal which is transmitted by modulating an electromagnetic radiation may simply be an indication of the type of area, such as parking, pedestrian area, one-way or no-way street, proximity of a pedestrian crossing, etc.

The data signal is not necessarily transmitted by modulating the intensity of the electromagnetic radiation. Indeed, other known types of modulation may be implemented such as frequency modulation or pulse width modulation, the radiation being emitted in the form of pulse trains.

1. A method for monitoring a remotely controllable member, the method comprising steps consisting in:
emitting a data signal by an electromagnetic radiation source by modulation of the electromagnetic radiation;
providing a receiver of the electromagnetic radiation, the source and the receiver being coupled respectively to a fixed point and to a movable object or vice versa;
providing a masking device comprising one or several elements masking the electromagnetic radiation, the masking device being configured to limit an emission field of the source and/or a reception field of the receiver to a transmission area including the fixed point and defined by the masking device; and
when the receiver receives the data signal, implying that the receiver is located in the transmission area and oriented towards the emitter:
extracting data from the data signal by a processing unit connected to the receiver;
selecting by the processing unit a predefined command executable by the remotely controllable member, according to the extracted data without requiring a position calculation of the movable object;
transmitting the command by the processing unit to the remotely controllable member; and
executing the command by the remotely controllable member.

2. The method according to claim 1, comprising steps consisting in:
receiving by at least two receivers of a set of receivers installed on the movable object two data signals transmitted by electromagnetic radiation emitted respectively by two electromagnetic radiation fixed sources, the field of emission and/or reception of the data signals emitted by each of the two sources being limited to a respective transmission area defined by a masking device;
extracting, by the processing unit of the movable object linked to the set of receivers, an identifier of the electromagnetic radiation source from each received data signal;
determining by the processing unit of the movable object linked to the set of receivers, a location area and a direction of a preferred axis of movement of the movable object in a plane of movement of the movable object, according to the identifiers of the two electromagnetic radiation sources and of the receivers having received the data signals, and
executing by the processing unit, a command of an electromechanical member (CC) of the movable object according to the location area and the direction of the preferred axis of movement of the movable object.

3. The method according to claim 1, wherein the command belongs to a set of commands comprising:
a command to limit the speed of the movable object,
a command to stop the movement of the movable object, and
a command to lock the movable object.

4. The method according to claim 1, comprising steps consisting in:
determining by the processing unit whether the location area of the movable object is located in an authorized parking area of the movable object according to the emitter identifier,
executing by the processing unit an end-of-use command when the location area is in an authorized parking area, the end-of-use command comprising a command to lock the movable object, and a transmission to a remote server of an end-of-use notification message, containing location data and an identifier of the movable object, and
not executing by the processing unit the end-of-use command until the location area is in an authorized parking area.

5. The method according to claim 1, wherein the movable object is located in an area comprising a plurality of emitters of data signals, the method further comprising a step of determining a geographic position of the movable object according to the emitter identifier extracted from the signal received from one of the emitters.

6. The method according to claim 1, wherein the data signal is emitted by modulation of the supply current of an electromagnetic radiation source, belonging to the emission installation.

7. The method according to claim 6, wherein the modulation of the supply current is of the SPWM type.

8. A system for monitoring a remotely controllable member, the system comprising:
an electromagnetic radiation source emitting a data signal by modulation of the electromagnetic radiation,
a receiver of the electromagnetic radiation, the source and the receiver being coupled respectively to a fixed point and to a movable object or vice versa,
a masking device comprising one or several elements masking the electromagnetic radiation, the masking device being configured to limit an emission field of the source and/or a reception field of the receiver to a transmission area including the fixed point and defined by the masking device, and
a processing unit configured to implement the method according to claim 1.

9. The device according to claim 8, wherein the receiver comprises a front receiver block to be installed in a front position of the movable object and a rear receiver block to be installed in a rear position of the movable object, each of the front and rear receiver blocks being connected to the processing unit and bringing together several electromagnetic radiation reception units, the masking device comprising masking elements associated with the reception units of each of the front and rear receiver blocks, the masking elements having distinct orientations so that the reception units capture electromagnetic radiation having distinct orientations.

10. The device according to claim 8, wherein the receiver comprises an image sensor, the processing unit being configured to analyze images provided by the image sensor in order to determine the presence of an image area having a predefined color.
